(19) United States
(12) Patent Application Publication
(10) Pub. No.: US 2012/0266100 A1
(43) Pub. Date: Oct. 18, 2012

(54) Dynamic Tile Billboard User Interface

(76) Inventors: Neal Robert Caliendo, JR., Raleigh, NC (US); Timothy L. Humphrey, Raleigh, NC (US); Lisa Louise Carter, Durham, NC (US); Paul Douglas Plaskonos, Raleigh, NC (US); Adam Miles Smith, Chapel Hill, NC (US); Russell Speight VanBlon, Raleigh, NC (US); Adriana Arceo Villarreal, Raleigh, NC (US)

(21) Appl. No.: 13/084,887

(22) Filed: Apr. 12, 2011

(51) Int. Cl. G06F 3/048

(52) U.S. Cl. 715/781; 715/764

(57) ABSTRACT

According to one disclosed embodiment, an approach is provided in which a user action directed at a selected graphical user interface (GUI) control displayed on a display screen is received at a machine. The selected GUI control corresponds to a software application and the selected GUI control is used to launch the software application. The system detects that the user action is a billboard request. Billboard data corresponding to the software application is retrieved and displayed on the display screen. In addition, the displaying of the billboard data inhibits execution of the software application.

### BACKGROUND

The present invention relates to an approach that provides intermediate informational functionality regarding an applet or application without invoking the applet or application.

Additional information describing the functionality of a tile/applet/application is traditionally available only after installing or launching the underlying application. Traditional solutions provide this descriptive information by launching the actual application and having the user navigate a help or tutorial system provided by the application.

### BRIEF SUMMARY

According to one disclosed embodiment, an approach is provided in which a user action directed at a selected graphical user interface (GUI) control displayed on a display screen is received at a machine. The selected GUI control corresponds to a software application and the selected GUI control is used to launch the software application. The system detects that the user action is a billboard request. Billboard data corresponding to the software application is retrieved and displayed on the display screen. In addition, the displaying of the billboard data inhibits execution of the software application.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing a user requesting a billboard function corresponding to a tile using a particular gesture in which the tile is a graphical user interface (GUI) appearing on a display screen;

FIG. 4 is a flowchart showing the steps performed when the user makes a selection using a gesture or other user input on a display screen;

FIG. 5 is a flowchart showing the steps performed to display a billboard corresponding to a tile in response to a selection received from the user in FIG. 4.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

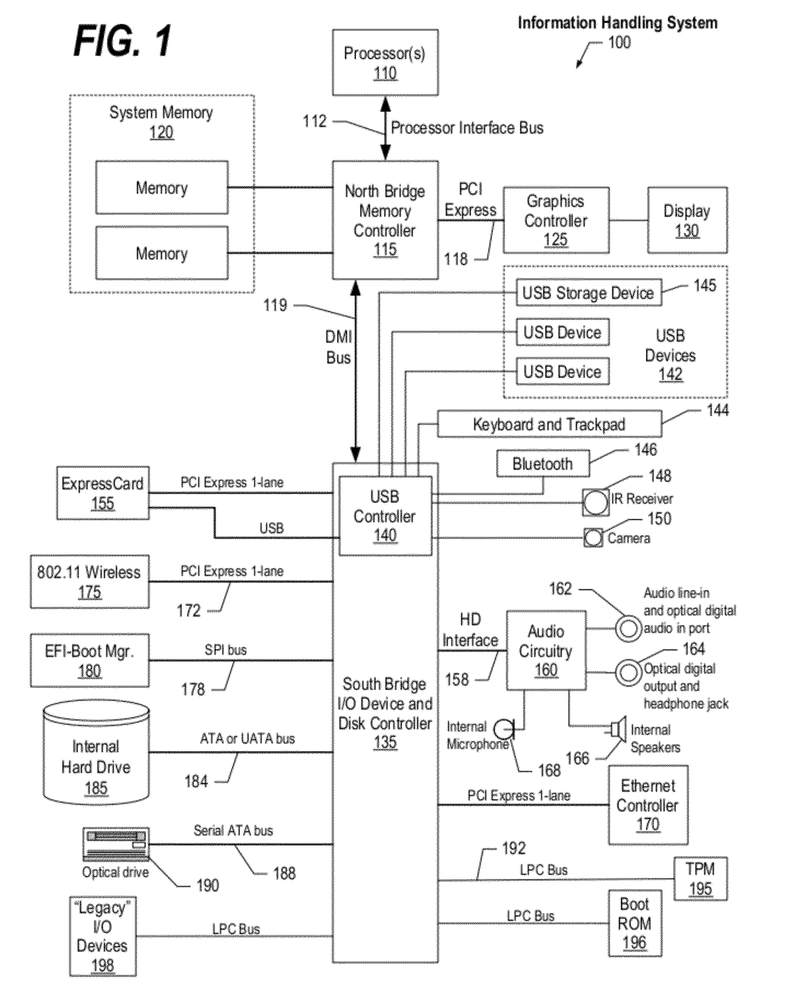

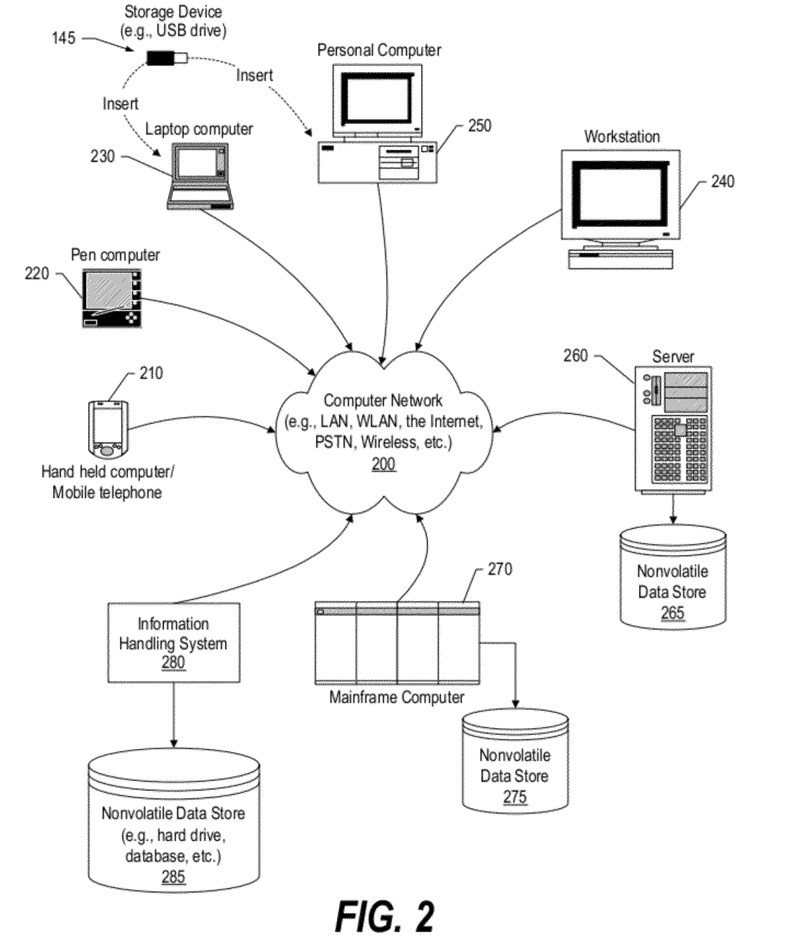

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

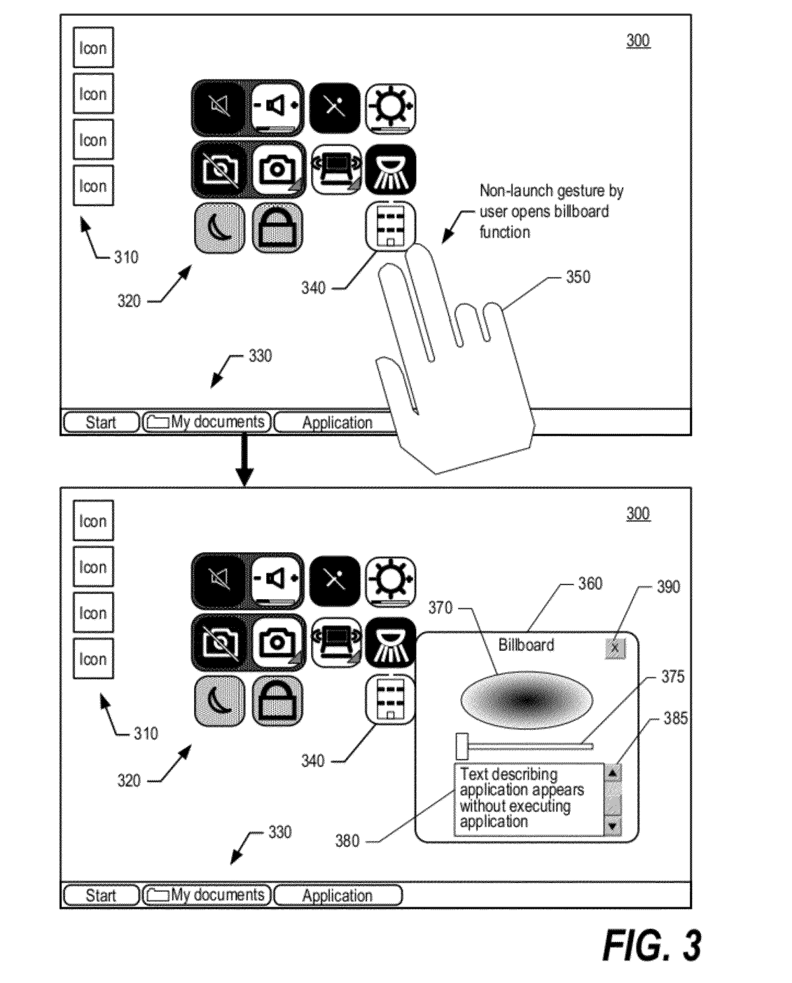

FIG. 3 is a diagram showing a user requesting a billboard function corresponding to a tile using a particular gesture in which the tile is a graphical user interface (GUI) appearing on a display screen. The information handling system is shown with a plurality of graphical user interface (GUI) controls, such as tiles 320 and icons 310, displayed on display screen 300. Title bar 330 is also displayed at the bottom of the display. One of the GUI controls (GUI control 340) is currently being selected by user 350 using a hand gesture on a touch-enabled display screen. In another embodiment, selected GUI control 340 is selected by the user using a mouse or other selection device. The user is selecting GUI control 340 using an alternate user action (e.g., a single tap or single click, etc.), instead of using a primary user action (e.g., a double tap or double click, etc.) that is used to launch the software application corresponding to selected GUI control 340.

The bottom part of FIG. 3 shows billboard window 360 that is displayed in response to the alternate user action. Billboard window 360 includes multimedia viewer 370 used to display a multimedia presentation regarding the software application along with multimedia control bar 375 used to fast forward and rewind the multimedia presentation. Billboard window 360 also includes textual display area 380 that is used to display a textual description of the software application along with scroll bar 385 which is used to visually scroll through textual display area 380. Close control 390 is selected by the user to close billboard window 360 when the user is finished viewing. Selecting close window control 390 removes the billboard window from the display with the resulting display being like the top half of FIG. 3.

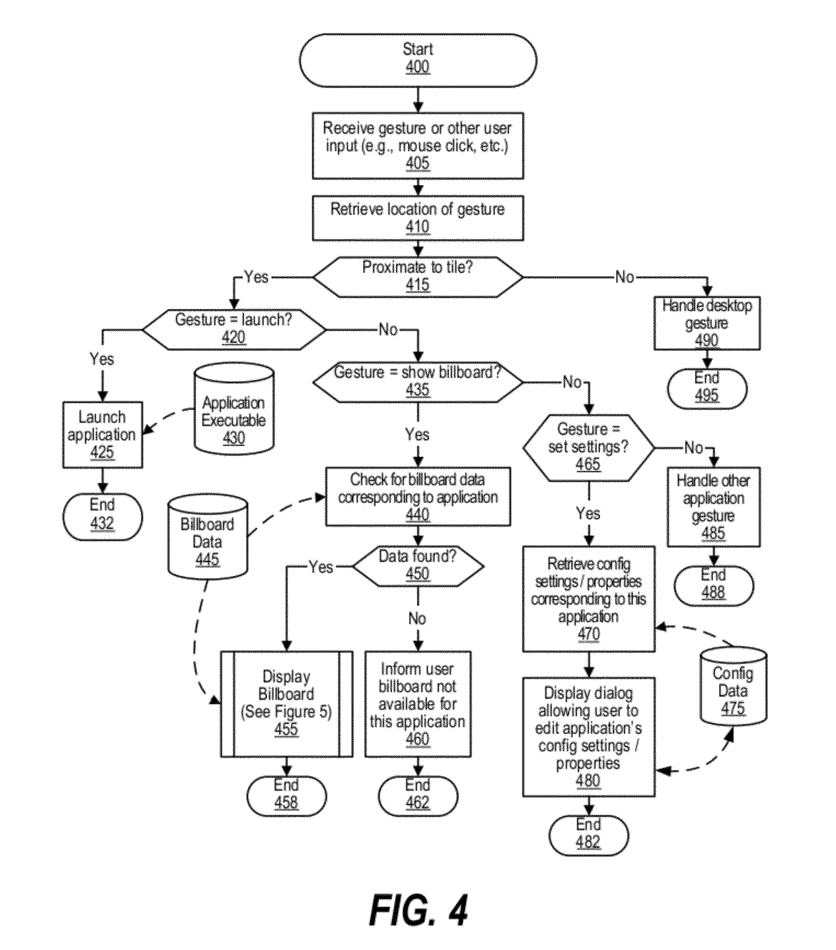

FIG. 4 is a flowchart showing the steps performed when the user makes a selection using a gesture or other user input on a display screen. Processing commences at 400 whereupon, at step 405, a user action is received at the information handling system. The user action may be a finger gesture directed at a touch-enabled display screen or a different type of action, such as a mouse action. At step 410, the location of the user action is retrieved from the operating system. A decision is made as to whether the user action is proximate to a GUI control that is displayed on the display screen (decision 415). If the user action is proximate to a GUI control, then that GUI control becomes the selected GUI control and processing branches to the “yes” branch. A decision is made as to whether the user action is requesting to launch (execute) the software application corresponding to the selected GUI control (decision 420). If the user action (e.g., a double finger tap or double mouse click, etc.) is an action used to launch the software application, then decision 420 branches to the “yes” branch whereupon, at step 425, the executable file or files corresponding to the selected GUI control are launched by retrieving the executables from nonvolatile data store 430 and executing the software application by the operating system. Processing thereafter ends at 430.

Returning to decision 420, if the user action was not to launch the software application, then a decision is made as to whether the user action is to show a billboard with information corresponding to the software application (decision 435). If the user action is an action used to request the display of a billboard with software application information (e.g., a single finger tap, a single mouse click, etc.), then decision 435 branches to the “yes” branch whereupon, at step 440, processing checks for billboard data that corresponds to the software application that corresponds to the selected GUI control. A decision is made as to whether billboard data corresponding to the software application is found (decision 450). If billboard data corresponding to the software application is found, then decision 450 branches to the “yes” branch whereupon, at predefined process 455, the billboard data is displayed to the user on the display screen per user and/or system preferences. Processing thereafter ends at 458. On the other hand, if no billboard data corresponding to the software application was found, then decision 450 branches to the “no” branch whereupon, at step 460, an error message is displayed informing the user that billboard data is not available for the software application that corresponds to the selected GUI control.

Returning to decision 435, if the user action is not to launch the software application or to display the billboard information, then decision 435 branches to the “no” branch whereupon a decision is made as to whether the user action is to set software (configuration) settings corresponding to the software application that corresponds to the selected GUI control (decision 465). If the user action is to set software application configuration settings (e.g., a triple finger tap, a triple mouse click, etc.) then decision 465 branches to the “yes” branch whereupon, at step 470, configuration settings that correspond to the software application are retrieved from configuration data store 475. At step 480, the retrieved configuration settings are displayed in a dialog that allows the user to alter (edit) the configuration settings corresponding to the software application. Processing thereafter ends at 482. On the other hand, if the user action is not to launch, display a billboard, or set configuration settings, then decision 465 branches to the “no” branch whereupon, at step 485, some other user action is handled and processing thereafter ends at 495.

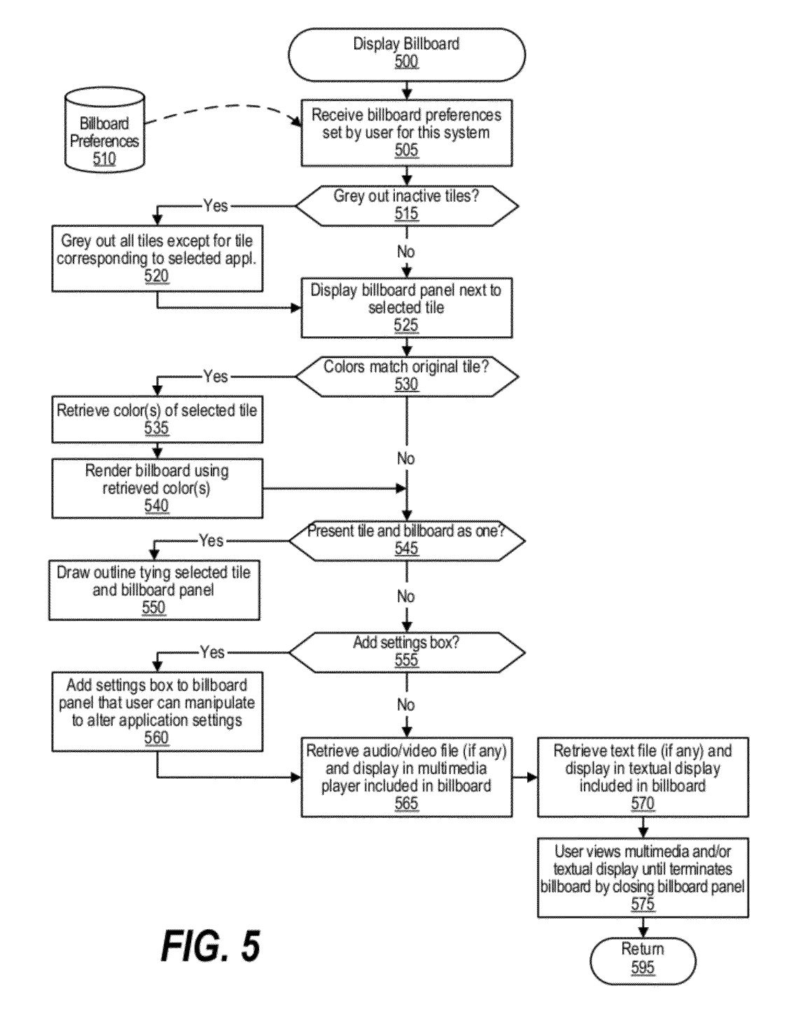

FIG. 5 is a flowchart showing the steps performed to display a billboard corresponding to a tile in response to a selection received from the user in FIG. 4. Display billboard processing commences at 500 whereupon, at step 505, the user's billboard preferences (or default preferences if not set by the user) are retrieved from billboard preferences data store 510.

A decision is made, based on the retrieved preferences as to whether to visually inactivate the non-selected GUI controls displayed on the display screen (decision 515). If non-selected GUI controls are to be visually inactivated, then decision 515 branches to the “yes” branch whereupon, at step 520 all GUI controls displayed on the display screen are shown as inactivated (e.g., grayed out, etc.). Visually inactivating the non-selected GUI controls is performed by rendering the non-selected GUI controls in a muted color palate. The selected GUI control is displayed as visually activated by rendering the selected GUI control in an active color palate. The billboard data is displayed in a billboard window on the display screen with the billboard window also being rendered in the active color palate.

A decision is made, based on the retrieved preferences as to whether to use the same colors to render the billboard window as were used to render the selected GUI control (decision 530). If the preference is to render the billboard window in the same colors as the selected GUI control, then decision 530 branches to the “yes” branch whereupon, at step 535, the colors used to render the selected GUI control are retrieved and, at step 540, the billboard data is displayed in a billboard window on the display screen rendered using the colors that were retrieved from the selected GUI control.

A decision is made, based on the retrieved preferences as to whether to visually present the selected GUI control and the billboard window with an outline that ties the selected GUI control and the billboard window together (decision 545). If the preference is to visually present the selected GUI control and the billboard window with an outline that ties the selected GUI control and the billboard window together, then decision 545 branches to the “yes” branch whereupon, at step 550, a billboard window is displayed adjacent to the selected GUI control with the billboard window used to display the billboard data and a visual outline is displayed around both the selected GUI control and the billboard window to visually tie the selected GUI control and the billboard window as a single visible panel.

A decision is made, based on the retrieved preferences as to whether to include a settings GUI control in the billboard window that allows the user to select in order to display a dialog with the software application's configuration settings (decision 555). If the preference is to include a settings box, then the retrieved billboard data is displayed in a billboard window and the billboard window includes a settings control (e.g., setting GUI control, etc.). When the user selects the settings control from the billboard window, then settings corresponding to the software application are retrieved and displayed in a settings dialog. The user can then change the displayed configuration settings and these changes are used to update the configuration settings of the software application. Moreover, the user is able to alter the software application's configuration settings without ever invoking or otherwise executing the software application.

At step 565, a multimedia (audio/visual) file corresponding to the software application is retrieved and displayed in a multimedia player that is included in the displayed billboard window (see, e.g., multimedia player 370 within billboard window 360 shown in FIG. 3). At step 570, a textual file corresponding to the software application is retrieved and displayed in a textual display area that is included in the displayed billboard window (see, e.g., textual display area 380 within billboard window 360 shown in FIG. 3). At step 575, the user views billboard data displayed in the billboard window including any multimedia files displayed in the billboard window's multimedia player and any text files displayed in the billboard window's textual display area. The user's viewing of the billboard data using the billboard window continues until the user terminates the billboard by closing the billboard window (e.g., by using a close control included in the billboard window, etc.). Processing then returns to the calling routine (see FIG. 4) at 595.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A machine-implemented method comprising:
receiving a user action directed at a selected graphical user interface (GUI) control displayed on a display screen, the selected GUI control corresponding to a software application, wherein the selected GUI control is used to launch the software application, and wherein the user action is received from a user of the machine;
detecting that the user action is a billboard request;
retrieving a billboard data corresponding to the software application; and
displaying the retrieved billboard data on the display screen, wherein the displaying inhibits execution of the software application.

2. The method of claim 1 wherein the user action is an alternate gesture, wherein the display screen is a touch-enabled display screen, and wherein a primary gesture is used to launch the software application.

3. The method of claim 1 wherein the user action is an alternate mouse click event, and wherein the primary mouse click event is used to launch the software application.

4. The method of claim 1 wherein the displaying of the retrieved billboard data further comprises:
displaying a billboard window adjacent to the selected GUI control, wherein the billboard window displays the billboard data; and
displaying an outline that visually ties the selected GUI control and billboard window as a single visual panel.

5. The method of claim 1 wherein the displaying of the retrieved billboard data further comprises:
retrieving one or more colors included in the selected GUI control; and
displaying a billboard window on the display screen, wherein the billboard window is rendered using the retrieved colors, and wherein the retrieved billboard data is displayed in the billboard window.

6. The method of claim 1 wherein a plurality of GUI controls are displayed on the display screen in addition to the selected GUI control, and wherein the displaying of the retrieved billboard data further comprises:
visually inactivating the plurality of GUI controls, the visually inactivating performed by rendering the plurality of GUI controls in a muted color palate;
visually activating the selected GUI control by rendering the selected GUI control in an active color palate; and
displaying the billboard data in a billboard window on the display screen, wherein the billboard window is rendered in the active color palate.

7. The method of claim 1 further comprising:
displaying the billboard data in a billboard window on the display screen, wherein the billboard window includes a settings control;
receiving a second user action directed at the settings control displayed on a display screen;
retrieving one or more settings corresponding to the software application;
displaying a settings dialog on the display that includes the retrieved settings;
receiving one or more settings changes from the user; and
updating the settings corresponding to the software application, wherein the updating is performed while inhibiting the execution of the software application.

8. An information handling system comprising:
one or more processors;
a memory coupled to at least one of the processors;
a display screen accessible by at least one of the processors; and
a set of computer program instructions stored in the memory and executed by at least one of the processors in order to perform actions of:
receiving a user action directed at a selected graphical user interface (GUI) control displayed on a display screen, the selected GUI control corresponding to a software application, wherein the selected GUI control is used to launch the software application, and wherein the user action is received from a user of the machine;
detecting that the user action is a billboard request;
retrieving a billboard data corresponding to the software application; and
displaying the retrieved billboard data on the display screen, wherein the displaying inhibits execution of the software application.

9. The information handling system of claim 8 wherein the user action is an alternate gesture, wherein the display screen is a touch-enabled display screen, and wherein a primary gesture is used to launch the software application.

10. The information handling system of claim 8 wherein the user action is an alternate mouse click event, and wherein the primary mouse click event is used to launch the software application.

11. The information handling system of claim 8 wherein the displaying of the retrieved billboard data further includes additional actions performed by the processors comprising:
displaying a billboard window adjacent to the selected GUI control, wherein the billboard window displays the billboard data; and
displaying an outline that visually ties the selected GUI control and billboard window as a single visual panel.

12. The information handling system of claim 8 wherein the displaying of the retrieved billboard data further includes additional actions performed by the processors comprising:
retrieving one or more colors included in the selected GUI control; and
displaying a billboard window on the display screen, wherein the billboard window is rendered using the retrieved colors, and wherein the retrieved billboard data is displayed in the billboard window.

13. The information handling system of claim 8 wherein a plurality of GUI controls are displayed on the display screen in addition to the selected GUI control, and wherein the displaying of the retrieved billboard data further includes additional actions performed by the processors comprising:
visually inactivating the plurality of GUI controls, the visually inactivating performed by rendering the plurality of GUI controls in a muted color palate;
visually activating the selected GUI control by rendering the selected GUI control in an active color palate; and
displaying the billboard data in a billboard window on the display screen, wherein the billboard window is rendered in the active color palate.

14. The information handling system of claim 8 wherein the processors perform additional actions comprising:
displaying the billboard data in a billboard window on the display screen, wherein the billboard window includes a settings control;
receiving a second user action directed at the settings control displayed on a display screen;
retrieving one or more settings corresponding to the software application;
displaying a settings dialog on the display that includes the retrieved settings;
receiving one or more settings changes from the user; and
updating the settings corresponding to the software application, wherein the updating is performed while inhibiting the execution of the software application.

15. A program product stored in a machine readable storage medium, comprising program code that, when executed by an information handling system, causes the information handling system to perform actions comprising:
receiving a user action directed at a selected graphical user interface (GUI) control displayed on a display screen, the selected GUI control corresponding to a software application, wherein the selected GUI control is used to launch the software application, and wherein the user action is received from a user of the machine;
detecting that the user action is a billboard request;
retrieving a billboard data corresponding to the software application; and
displaying the retrieved billboard data on the display screen, wherein the displaying inhibits execution of the software application.

16. The program product of claim 15 wherein the user action is an alternate gesture, wherein the display screen is a touch-enabled display screen, and wherein a primary gesture is used to launch the software application.

17. The program product of claim 15 wherein the user action is an alternate mouse click event, and wherein the primary mouse click event is used to launch the software application.

18. The program product of claim 15 wherein the displaying of the retrieved billboard data further comprises:
displaying a billboard window adjacent to the selected GUI control, wherein the billboard window displays the billboard data; and
displaying an outline that visually ties the selected GUI control and billboard window as a single visual panel.

19. The program product of claim 15 wherein the displaying of the retrieved billboard data further comprises:
retrieving one or more colors included in the selected GUI control; and
displaying a billboard window on the display screen, wherein the billboard window is rendered using the retrieved colors, and wherein the retrieved billboard data is displayed in the billboard window.

20. The program product of claim 15 wherein a plurality of GUI controls are displayed on the display screen in addition to the selected GUI control, and wherein the displaying of the retrieved billboard data further comprises:
visually inactivating the plurality of GUI controls, the visually inactivating performed by rendering the plurality of GUI controls in a muted color palate;
visually activating the selected GUI control by rendering the selected GUI control in an active color palate; and
displaying the billboard data in a billboard window on the display screen, wherein the billboard window is rendered in the active color palate.
